(19) United States
(12) Patent Application Publication
(10) Pub. No.: US 2008/0056084 A1
(43) Pub. Date: Mar. 6, 2008

(54) Method and System for Improving the Ability of Player/Recorder Systems to Read a Disc During the Startup Procedure

(75) Inventor: Jianyi Zhong, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/575,583

(22) PCT Filed: Sep. 29, 2004
(86) PCT No.: PCT/IB04/51907

§ 371 Date: Feb. 6, 2007

(30) Foreign Application Priority Data
Oct. 14, 2003 (CN) 200310102832.6

(51) Int. Cl. G11B 5/58

(52) U.S. Cl. 369/53.17

(57) ABSTRACT

In accordance with the invention, upon insertion of an optical disc into a player/recorder system, the system attempts to recognize the disc and read data from the disc. Any error causing failure of a startup procedure will be detected. If a reading error is detected, the disc is rotated by an angle for minimizing the impacts due to the reading error. Then the data is read again from the disc. If a reading error is still detected, the procedure is repeated for a few times to minimize the reading errors. The rotational angle of the disc may be either preset or calculated by the system based on measured eccentricity values. In this way, the combined eccentricity, i.e., the distance from the spiral groove center of the disc to the system's rotational axis, can be minimized, and the ability of the system to read an optical disc during the startup procedure can be significantly improved.

### BACKGROUND OF THE INVENTION

The invention relates generally to disc player/recorder systems, and more particularly to a method and system for improving ability of player/recorder systems to read a disc during the startup procedure.

Disc players and recorders have been used to play back and record contents to and from optical discs. When an optical disc is inserted into a disc player, the player will try to recognize the disc and read out the Table of Contents for CDs, Control Data Zone for DVDs, or Address in Pre-groove for DVD+R/RW, etc. from the disc depending on the disc for mat, as a main part of its startup procedure. If the player cannot recognize the disc or fails to read out control data in the lead-in area, the player is unable to play back the contents on the disc. Thus, a successful startup is the first critical performance indicator of a disc player/recorder from users' perspective.

There are many factors that have impact on whether a disc player can successfully perform a startup procedure. For example, there are optical and mechanical discs errors in the lead-in area of a disc, caused by poor manufacturing processes and inappropriate handling by users. These errors can be categorized into two types. One type relates to global disc errors that exist in the entire disc, such as errors relating to eccentricity, axial deviations, radial tilts and tangential tilts, etc. The other type relates to local disc errors that appear only in certain small areas of a disc, such as scratches, black/white dots, fingerprints and geometrical distortions of pits and lands. Both types of disc errors would cause a disc player not to be able to recognize the disc.

Therefore, there is a need for a method and system to improve the startup performance of a disc player/recorder when an optical disc with the above-mentioned optical and mechanical errors is inserted into the disc player/recorder.

### SUMMARY OF THE INVENTION

In accordance with one embodiment of the invention, there provides a method and system for improving the ability of a player/recorder system to read a disc during the startup procedure. Upon insertion of an optical disc into a player/recorder system, the system attempts to recognize the disc and read out data from the disc. Whenever the system fails to read out a disc due to errors detected in either data path or servo path, it will be reported. To both minimize the impact of global disc errors on the system and avoid the critical shock by local disc errors, the disc is rotated by an angle with respect to the turntable for minimizing the impact of disc errors on the system. Then the data is read again from the disc. If the disc can still not be read out, the procedure is repeated for a few times to minimize the impact of disc errors on the system.

In a preferred embodiment of the invention, upon failing to read out a disc during startup procedure, the system rotates the disc by preset angles, measures the corresponding eccentricity of the disc with respect to a rotational axis of the system, and then determines a relative angle for rotating the disc for optimizing the eccentricity. Finally, the disc will be rotated by the determined angle to minimize the reading errors.

In this way, the eccentricity of the disc with respect to the system's rotational axis can be minimized, and the readability of the system can be significantly improved.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 illustrates the relative positions of the rotational axis of the rotational parts of a player/recorder system, the turntable center, the spiral groove center of a disc, and the relationship of the various eccentricities;

FIG. 2 illustrates a partial functional block diagram of a disc player/recorder system according to one embodiment of the invention;

FIG. 3 illustrates an eccentricity measurement and optimization process performed by the system controller of FIG. 2, according to another embodiment of the invention; and

FIG. 4 illustrates an example of minimizing the disc eccentricity according to the invention.

Throughout the drawings, the same reference numerals indicate similar or corresponding features or functions.

### DETAILED DESCRIPTION OF THE PREFERRED EMBODIMENTS

The invention significantly improves the ability of a disc player/recorder system during the startup procedure to recognize and read an optical disc (including ROM, recordable and rewriteable discs) with large optical and/or mechanical errors. This is achieved by making use of the manufacturing errors inherent in the player/recorder system to counteract certain disc errors to reduce the impact from the errors.

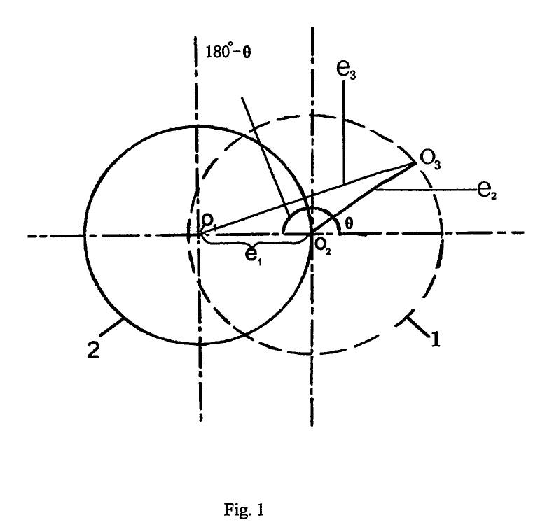

To better understand the invention, it is necessary to first appreciate the various eccentricities associated with imperfections of the rotational parts (including the turntable and the turntable motor) of a player/recorder system as well as a disc due to manufacturing processes. For example, in a player/recorder system, the rotational axis of the system's rotational parts may be off center and thus does not coincide with the turntable center. Further, the spiral groove center on a disc may also be off center and does not coincide with the center of disc central hole. The combined eccentricity as represented by the distance from the spiral groove center of a disc to the system's rotational axis (shown as e3 in FIG. 1), depends not only on the eccentricities of the rotational parts and the disc, but also on the relative positions of their eccentric centers, i.e., the rotational axis of the rotational parts, the turntable center, the spiral groove center of a disc which are illustrated in FIG. 1.

In FIG. 1, the rotational axis of a system's rotational part s is represented by O1; the turntable center is represented by O2; and the spiral groove center of a disc is represented by O3. Further, circle 1 represents a possible track of the disc spiral groove center O3, which encircles around turntable center O2, while circle 2 represents a possible track of the turntable center O2 around the rotational axis O1 of the system's rotational parts.

In this example, it is assumed that the central hole of the disc and the turntable are made perfectly, so that when a disc is placed on the turntable, the center of the disc central hole coincides with turntable center O2.

As shown in FIG. 1, the eccentricity of the turntalbe relative to system's rotational axis is represented by e1 (the distance between O1 and O2); and the disc eccentricity (i.e., the spiral groove center relative to the center of the central hole) is represented by e2 (the distance between O3 and O2). When the disc is played, the combined eccentricity (i.e., the distance from the disc spiral groove center to the system's rotational axis) is represented by e3 (the distance between O1 and O3), which can be derived as:

e3=(e1²+e2²−2e1*e2*cos(180°-θ))^{1/2} (1)

where (180°-θ) is the angle between e1 and e2;

when θ=180°, e3=|e1-e2|, which is a minimum value; and

when θ=0°, e3=|e1+e2|, which is the maximum value.

In other words, the combined eccentricity e3 varies from |e1-e2| to |e1+e2|, depending on the θ value and varies periodically as θ changes every 180°. Therefore, the impact from disc eccentricity can be minimized to |e1-e2| through selecting the optimum angle θ. Ideally, e3 could be zero if e1=e2.

From the experiments conducted by the inventor of this invention based on the specification defined for discs and common disc play-back systems, it has been determined that the eccentricity of a system's rotational parts is about equivalent to the eccentricity of a commercial disc. By appropriately adjusting angle θ between e1 and e2, the eccentricities of the system's rotational parts and the disc can counteract each other, so that the combined eccentricity can be dramatically reduced. This results in a significant increase in the success rate of the startup procedure of the bit engine in the system. By rotating the disc, at a minimum, the system can re-initialize the disc from a surface defect free or less defect area. This will result in a better startup performance .

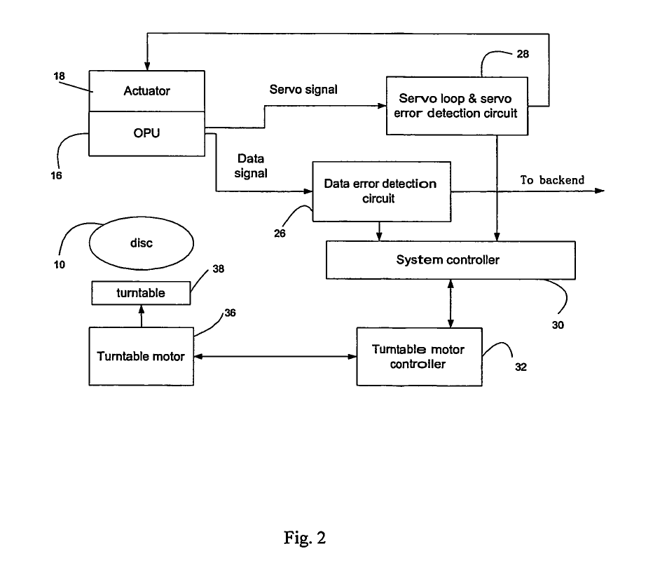

FIG. 2 illustrates a partial functional block diagram of a disc player/recorder system capable of minimizing the impact from disc errors in a startup procedure, according to one embodiment of the invention. In FIG. 2, other conventional components in the system are not illustrated for simplicity.

Upon insertion of a disc 10 into the system, an OPU 16 (including a photo diode) generates a laser beam for reading data from disc 10 and outputs corresponding data signals. A data error detection circuit 26 detects data errors in the data path and sends a data error report to a system controller 30 upon detecting an err or. Similarly, a servo loop and servo error detection circuit 28 detects a servo error generated by an actuator 18 in the servo path and sends a servo error report to system controller 30 upon detecting an error.

Upon receiving an error report from either data error detection circuit 26 or servo loop and servo error detection circuit 28, system controller 30 sends commands to a turntable motor controller 32 to initiate an optimization procedure. In this optimization procedure, turntable motor controller 32 first stops a turntable motor 36 and moves the turntable 38 down to release disc 10 from a clamper. Turntable motor 36 next rotates turntable 38 clockwise or counter clockwise by a preset angle for adjusting the relative positions of the spiral groove center of the disc to the rotational axis of the system's rotational parts to reduce the combined eccentricity of the rotational parts and the disc. Then, turntable motor 36 moves turntable 38 up to hold the disc with the damper and rotate s turntable 38 at a normal speed.

Thereafter, if system controller 30 does not receive any further error reports, the normal startup procedure is followed. On the other hand, if system controller 30 continues to receive an error report from either one of circuits 26 and 28, the optimization procedure is repeated until the system controller receives no further error reports or until the optimization procedure is repeated a few times (typically six times). In the latter case, it is likely that the disc has a fatal defect that cannot be cured by the system.

In a preferred embodiment of the present invention, the system is configured to perform an N-loop optimization procedure and the preset angle is equal to 180/N degrees. Obviously, the larger N is, the more likely the optimization procedure can minimize the combined eccentricity. However, this would take more times. In accordance with a preferred embodiment of the invention, an optimal value of N has been experimentally determined to be 6.

Alternatively, the disc player/recorder system can also prompt the user to manually rotate the disc by a certain angle θ (e.g., 30° clockwise or counter-clockwise) and then play the disc again. If the system still cannot read the disc, the user will again be prompted to rotate the disc until the startup procedure is successfully initiated.

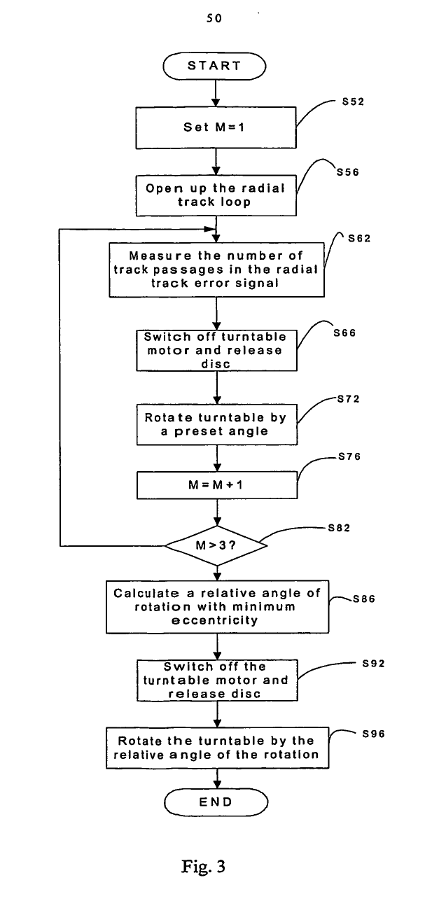

In another embodiment of the invention that is similar to the above embodiment, instead of rotating the disc by a preset angle upon detecting an error, the system will measure the combined eccentricity at different θ angles. Based on the measurements, a relative angle of rotation with the minimum eccentricity value can be calculated. The detailed description is provided below in connection with FIG. 3.

FIG. 3 illustrates an eccentricity measurement and optimization process 50 performed by system controller 30 in FIG. 2, according to another embodiment of the invention. In process 50, the system controller sets a parameter M to 1 (step S52), and opens up the radial track loop to make it inoperative, while maintaining the focus loop closed (step S56). Then, the controller measures the number of the track passages in the radial error signals (i.e., the number of tracks detected in one complete revolution of the disc) (step S62). From this measurement, a corresponding eccentricity value is derived. The profile of the combined eccentricity has a sine wave shape with respect to the rotation angle. A similar method of measuring eccentricity is disclosed in a Japanese Patent No. JP09229650, issued to Katsura Shinichi et al., filed on Feb. 21, 1996, entitled “Detecting Method and Device for Eccentricity, Inclination and Warp”, which is incorporated herein by reference.

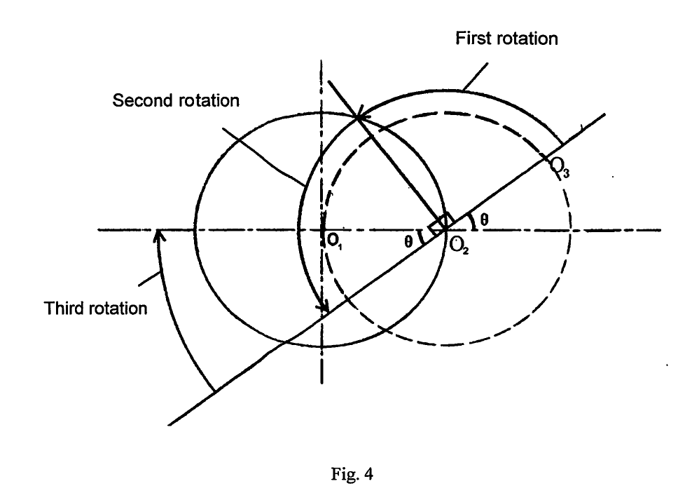

Next, the controller switches off the turntable motor and causes the disc to be released (step S66). Then the controller causes the turntable to rotate by a preset angle counter-clockwise (or clockwise), preferably 90° (step S72), and M is incremented by 1 (step S76). If M is not greater than 3, steps S62 through S76 will be repeated. After the combined eccentricity is measured for three times at three different angles, θ (i.e., the initial position of disc), (θ+90°) and (θ+180°), as illustrated in FIG. 4, the following three equations are respectively obtained, with each being equivalent to the Equation 1 in the above,

E₁=(a₁+a₂ cosθ)^{1/2}

E₂=(a₁+a₂ cos(θ+90°))^{1/2}

E₃=(a₁+a₂ cos(θ+180°))^{1/2}

where each of E₁, E₂ and E₃ represents a measured combined eccentricity value.

From the above three equations, the controller calculates the value of θ and determines a relative angle of rotation with the minimum eccentricity value (step S86). Thereafter, the controller switches off the turntable motor and causes the disc to be released (step S92). Finally, the controller causes the turntable to rotate by the relative angle of rotation as determined above (step S96). This relative angle of rotation is achieved simply by rotating the disc by the angle θ clockwise (or counter-clockwise). Then, when the disc is clamped on the turntable, the minimum disc eccentricity can be achieved. This process may be repeated for several times during the startup procedure at slightly different angles in case the relative angle of rotation as determined is not as accurate as expected.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

1. A method for improving the ability to read an optical disc during a startup procedure, comprising the steps of:
(a) reading data from the disc;
(b) detecting any reading error causing failure of step (a); and
(c) if a reading error causing failure of step (a) is detected, rotating the disc by an angle for minimizing the impact of the errors.

2. The method of claim 1, further comprising the step of:
(d) if the reading error is detected, after step (c), reading data from the disc.

3. The method of claim 2, further comprising the step of:
(e) if the reading error is detected, after step (d), repeating steps (c) through (d).

4. The method of claim 1, wherein the angle is preset.

5. The method of claim 1, further comprising the step of:
if the reading error is detected, determining an angle for rotating the disc for minimizing the reading error, and the disc is rotated by the determined angle.

6. The method of claim 5, further comprising the step of:
if the reading error is detected, measuring an eccentricity of the disc with respect to a rotational axis of a system in which the disc is being read, and the angle is determined based on a minimum eccentricity value measured.

7. A method for improving the ability to read an optical disc during a startup procedure, comprising the steps of:
(a) reading data from the disc;
(b) detecting any reading error causing failure of step (a); and
(c) if a reading error causing failure of step (a) is detected, prompting a user to rotate the disc by an angle for minimizing the impact of the error.

8. The method of claim 7, further comprising the step of:
(d) if the reading error is detected, after step (c) and the user has rotated the disc, reading data from the disc.

9. The method of claim 8, further comprising the step of:
(e) if the reading error is detected, after step (d), repeating steps (c) through (d).

10. The method of claim 1, wherein the reading error includes at least one of a data error and a servo error.

11. A disc player system with improved capability to read an optical disc, comprising:
means for reading data from the disc during a startup procedure;
means for detecting any reading error causing failure of the startup procedure; and
means for rotating the disc by an angle for minimizing impact on the system due to disc errors, the rotating means rotating the disc if the reading error is detected.

12. The system of claim 11, wherein if the reading error is detected and the disc has been rotated, the reading means again reads data from the disc.

13. The system of claim 12, wherein:
if the reading error is detected and the disc has been rotated and read again, the detecting means again detects any reading error causing failure of the startup procedure,
the rotating means again rotates the disc by an angle for minimizing the impact on the system due to disk errors if a reading error is again detected, and
the reading means again reads data from the disc if the reading error is again detected.

14. The system of claim 11, wherein the angle is preset.

15. The system of claim 11, further comprising:
means for determining an angle for rotating the disc for minimizing impact on the system due to disk errors, the determining means determining the angle if the reading error is detected;
wherein if the reading error is detected, the rotating means rotates the disc by the determined angle.

16. The system of claim 15, further comprising:
means for measuring an eccentricity of the disc with respect to a rotational axis of the system, and
wherein if the reading error is detected, the determining means determines the angle based on a minimum eccentricity value measured.

17. A disc player system with improved capability to read an optical disc, comprising:
means for reading data from the disc during a startup procedure;
means for detecting any reading error causing failure of the startup procedure; and
means for prompting a user to rotate the disc by an angle for minimizing impact on the system due to disk errors, the prompting means prompting the user if the reading error is detected.

18. The system of claim 17, wherein if the reading error is detected and the disc has been rotated, the reading means again reads data from the disc.

19. The system of claim 18, wherein:
if the reading error is detected and the disc has been rotated and read again, the detecting means again detects any error causing failure of the startup procedure,
the prompting means again prompts the user to rotate the disc by an angle for minimizing the impact of disk errors if a reading error is again detected, and
the reading means again reads data from the disc if the reading error is again detected.

20. The system of claim 11, wherein the reading error includes at least one of a data error and a servo error causing failure of a startup procedure.
